(19) United States
(12) Patent Application Publication
(10) Pub. No.: US 2006/0294555 A1
(43) Pub. Date: Dec. 28, 2006

(54) Method and system for video on demand (VOD) servers to cache content

(75) Inventor: Jianhua Xie, Colorado Springs, CO (US)

Correspondence Address: JIANHUA XIE, 2405 ROYAL PALM DR., COLORADO SPRINGS, CO, 80918, US

(73) Assignee: Jianhua Xie, Colorado Springs (US)

(21) Appl. No.: 11/160,432

(22) Filed: Jun. 23, 2005

(51) Int. Cl. H04N 7/173

(52) U.S. Cl. 725/88; 725/102; 725/89; 725/94

(57) ABSTRACT

A method and system of enabling VOD systems efficiently caching contents (video programs) on its edge servers or user premises equipment. A new user interface and a new VOD system component are introduced. The new user interface allows viewers to specify not only the name of the video programs, but also the time and date they want to start watching them. The new VOD system component is used to receive and store video requests from users and calculate when is the best time to start caching the video programs requested to edge servers or user premises equipment based on a set of criteria, such as user input from the new user interface, network traffic condition pattern during a day, etc.

### BACKGROUND OF THE INVENTION

Video on Demand (VOD) is also known as “television on demand”, “movies on demand”, etc. It is a service enabling television viewers to select video programs (often movies like you would get from a video rental store) and have the programs send to them in the form called “streams”. VOD service can be implemented in an IPTV (Internet Protocol Television) network or a CATV (Cable Television) network in very similar manners. FIG. 1 is a diagram of an example IPTV network. It includes 4 parts, i.e., head end, IP backbone, central offices and user premises equipment. The ‘VOD Server’ is a piece of equipment in the head end to store video programs and send them to users when requested.

FIG. 2 is a flow chart of message exchanges between different pieces of equipment in an IPTV network when a viewer requests a video program:
(1) The viewer selects a video program using a remote controller;
(2) After knowing which video program the user wants to watch, the ‘STB 1’ (Set Top Box) sends out a request message to the ‘VOD Server’. This message flows first from ‘STB 1’ to ‘VOD Edge Server 1’, as marked as 101 in the diagram;
(3) Upon receiving the request message from ‘STB 1’, ‘VOD Edge Server 1’ forwards it to ‘Router 2’, as marked as 102;
(4) Upon receiving the request message from ‘VOD Edge Server1’, ‘Router 2’ forwards it to ‘Router 1’, as marked as 103;
(5) Upon receiving the request message from ‘Router 2’, ‘Router 1’ forwards it to the ‘VOD Server’, as marked as 104.
   Upon receiving the request message from ‘Router 1’, the ‘VOD Server’ sends out the video program in the form of a video stream to the user's TV. This video stream flows across different pieces of equipment as listed as follows:
(1) The ‘Video Server’ sends out the video program in the form of a video stream to ‘Router 1’, as marked as 201 in the diagram;
(2) ‘Router 1’ forwards the stream to ‘Router 2’, as marked as 202;
(3) ‘Router 2’ forwards the stream to ‘VOD Edge Server 1’, as marked as 203;
(4) ‘VOD Edge Server 1’ forwards the stream to ‘STB 1’, as marked as 204;
(5) ‘STB 1’ forwards the stream to ‘TV 1’ (possibly after processing), as marked as 205;
(6) The viewer starts watching the video program.

The video stream transfer mechanism depicted in FIG. 2 has an obvious shortcoming, i.e., every requested video program has to be transferred in the form of a video stream across the IP backbone. Since every video stream contains billions of bits and thousands of users may request different video programs at the same time, the IP backbone could get saturated quickly. To counter this problem, most commercial VOD systems employ some sort of caching mechanisms, i.e., storing some/all video programs on the local storages of ‘VOD Edge Servers’. In this way, some/all video programs do not have to be transferred from the ‘VOD Server’ to viewers' TVs across the IP backbone when requested. Instead, some/all video programs are directly transferred from ‘VOD Edge Servers’ to the viewers' TVs bypassing the IP backbone. The traffic on IP backbone is alleviated and the VOD system could support more concurrent viewers. Different caching algorithms dictate when and which video programs to be transferred from the ‘VOD Server’ to the ‘VOD Edge Servers’ for caching. The currently most used caching algorithms are “Push Update” (depicted in FIG. 3) and “Dynamic Stream Caching” (depicted in FIG. 4).

FIG. 3 depicts the “Push Update” caching mechanism. The ‘VOD Server’ periodically sends out all the new video programs to the ‘VOD Edge Servers’ in the form of streams for caching. The following is the message sequences for a typical cache updating process when “Push Update” method is used:
(1) ‘VOD server’ sends out a the video program in the form of a video stream to ‘Router 1’as marked as 101 in the diagram;
(2) ‘Router 1’ forwards the video stream to ‘Router 2’as marked as 102;
(3) ‘Router 2’ forwards the video stream to ‘Router 3’as marked as 104. At the same time, ‘Router 2’ drops a copy of the video stream to ‘VOD Edge Server 1’, as marked as 103;
(4) ‘Router 3’ forwards the video stream to ‘VOD Edge Server 2’, as marked as 105;
(5) Upon receiving the video stream, ‘VOD Edge Server 1’ stores the video program on its local ‘Storage 1’, as marked as 106;
(6) Upon receiving the video stream, ‘VOD Edge Server 2’ stores the video program on its local ‘Storage 2’, as marked as 107.

Also in FIG. 3, when a viewer requests to watch a video program, she/he selects the program using a remote controller. After knowing which video program the viewer wants, ‘STB 1’ sends out a message to ‘VOD Edge Server 1’, as marked as 201; upon receiving the request message, ‘VOD Edge Server 1’ fetches the video program from its local ‘Storage 1’ (remember the video program is cached on ‘Storage 1’ already) and sends it to ‘STB 1’ in the form of a video stream, as marked as 202; then ‘STB 1’ forwards the video stream to ‘TV 1’ (possibly after some processing on the stream), as marked as 203. The viewer now starts watching the video program.

The obvious shortcoming of the “Push Update” caching mechanism is the local storage for each ‘VOD Edge Server’, such as ‘Storage 1’ for ‘VOD Edge Server 1’ and ‘Storage 2’ for ‘VOD Edge Server 2’, has to be as large as the storage for the ‘VOD Server’, i.e., ‘Storage 0’, which need to hold all video programs. The storage for storing all the video programs is possibly huge, thus a VOD system demands lots of storage when “Push Update” caching method is employed.

FIG. 4 depicts the “Dynamic Stream Caching” method and the following is the sequence of message exchanges between VOD system components for a typical cache updating process when this caching method is used:
(1) A viewer picks a video program with a remote controller;
(2) After knowing which video program the viewer wants to watch, ‘STB 1’ sends out a request message to the ‘VOD Server’. The message travels firstly from ‘STB 1’ to ‘VOD Edge Server 1’, as marked as 101 in the diagram;
(3) ‘VOD Edge Server 1’ forwards the message to ‘Router 2’ (we assume ‘VOD Edge Server 1’ hasn't cached the video program yet), as marked as 102;
(4) ‘Router 2’ forwards the message to ‘Router 1’as marked as 103;
(5) ‘Router 1’ forwards the message to the ‘VOD Server’, as marked as 104;
(6) Upon receiving the request message, the ‘VOD Server’ sends out the video program in the form of a video stream to the ‘Router 1’, as marked as 105;
(7) ‘Router 1’ forwards the video stream to ‘Router 2’, as marked as 106;
(8) ‘Router 2’ forwards the video stream to ‘VOD Edge Server 1, as marked as 107;
(9) Upon receiving the video stream, ‘VOD Edge Server 1’ stores a copy of the video program to its local storage, ‘Storage 1’, as marked as 110. At the same time, it forwards the video stream to ‘STB 1’, as marked as 108;
(10) Finally, ‘STB 1’ forwards the video stream to ‘TV 1’ as marked as 109;
(11) The viewer starts watching the video program.

Also in FIG. 4, another viewer requests the same video program from ‘STB 2’. ‘STB 2’ sends out a request message to ‘VOD Edge Server 1’ as marked as 201 in the diagram. Instead of forwarding the request to the ‘VOD Server’, ‘VOD Edge Server 1’ simply fetches the video program from its local storage and sends it to ‘STB 2’ in the form of a video stream, as marked as 202. In this way, the video stream bypasses the IP backbone.

“Dynamic Stream Caching” method has two shortcomings. First, during the peak usage hours (say between 7 PM to 11 PM), if many viewers pick video programs that are yet to be cached on the ‘VOD Edge Servers’ at the same time, a lot of video streams would still have to be transferred on the IP backbone concurrently. The IP backbone might get saturated because of the heavy traffic. Second, ‘VOD Edge Servers’ store all video programs coming from the ‘VOD Server’, but the stored video programs may never be requested again and storage on the ‘VOD Edge Servers’ is wasted.

### DETAILED DESCRIPTION OF THE INVENTION

As discussed in previous paragraphs, current cache mechanisms have following shortcomings:
Huge storage (disks) needed for ‘VOD Edge Servers’ to store video programs when ‘Push Update’ caching method is used;
Video programs cached at ‘VOD Edge Servers’ may not be requested again and cache storage is wasted when “Dynamic Stream Caching” method is used;
At peak usage hours, the IP backbone may still be saturated when “Dynamic Stream Caching” method is used;

The invented caching method is called “Viewer Assisted” video caching. It uses viewers' input as a criterion in determining when and which video programs to be cached in which ‘VOD Edge Server(s)’. The invention is based on the observation that most TV viewers do not always watch video programs by happenstances. Most people live with schedules and for most of times TV viewers know when and which video programs they are going to watch a few hours or even a day earlier before they actually watch them. This user schedule information is valuable for improving efficiency for a VOD caching system as we will describe in the following paragraphs. To implement the “Viewer Assisted” caching mechanism, a new piece of equipment and a new user interface are added to the VOD system.

FIG. 6 is an example implementation of the new user interface which would be shown on TV screens to allow users to book a video program before they actually watch it. There are 4 choices to the question “when do you want to watch the video program?”, they are “Now”, “2 Hours from Now”, ∂8 Hours from Now” and “24 Hours from Now”.
If the “Now” option is selected, the ‘VOD Server’ will start transferring the video program immediately and the viewer can start watching the video program right away. Here we assume the video program is not cached in the ‘VOD Edge Server’ yet.
If the “2 Hours from Now” option is selected, the ‘VOD Server’ will start caching the video program some time within 2 hours. The viewer will be able to start watching the video program any time after 2 hours since he/she books the video program.
If the “8 Hours from Now” option is selected, the ‘VOD Server’ will start caching the video program some time within 8 hours. The viewer will be able to start watching the video program any time after 8 hours since he/she books the video program.
If the “24 Hours from Now” option is selected, the VOD Server will start caching the video program some time within 24 hours. The viewer will be able to start watching the video program any time after 24 hours since he/she books the video program.

FIG. 7 is another example implementation of the new user interface. Instead of having a list of defined options, it asks the users to input the date and time they wish to start watching the video programs they choose.

The added equipment is called ‘Cache Schedule Server’. All the video programs requests are sent to the ‘Cache Schedule Server’, either directly from routers or forwarded from the ‘VOD Server’. The ‘Cache Schedule Server’ decides when to start caching the video programs to ‘VOD Edge Server(s)’ based on criteria listed below among others:
(1) Viewer selected schedule options, i.e., “Now”, “2 Hours from Now”, “8 Hours from Now” or “24 Hours from Now” when the example user interface as discussed in [Para 12] is used. For example, if the viewer selects “Now” option, the “Cache Schedule Server” has no choice by to start caching the video program immediately. On the other hand, if the viewer selects “8 Hours from Now” option, then the ‘Cache Schedule Server’ could start caching the video program any time within 8 hours. The exact time it picks is determined by other caching criteria;
(2) Network traffic pattern during a day. The traffic on the IP backbone of an IPTV network which supports VOD service is not even during a day. On one hand, during peak usage hours, say between 7 PM to 11 PM, a lot of viewers are watching TV and traffic on the network is very heavy. On the other hand, during low usage hours, say between 3 AM to 5 AM, few viewers are watching TV and traffic on the network is very light. This statistical pattern can help the ‘Cache Schedule Server’ to smooth out the network traffic. For example, if a viewer books a video program at 8 PM today and decides to watch it 8 PM tomorrow, the ‘Cache Schedule Server’ should not start caching the video program immediately after it receives the request (because it is peak usage hour at 8 PM and there is no hurry to cache the video program anyhow). Instead, the ‘Cache Schedule Server’ waits till 3 AM the next day to start caching the video program. In this way, more VOD users can be supported on an IPTV network.

To encourage viewers providing the schedule information as early as possible, economic incentives may be provided for early ordering. For example, leveled prices are asked for different options. In the example user interface shown in FIG. 6, “NOW” option is priced at 12 dollars, “2 Hours from NOW” option 10 dollars, so on and so forth. Users use remote controllers to choose options that meet their schedules best. For example, it is 6 PM now and a viewer wants to watch the video program at 9 PM, then the most appropriate option for the view is “2 Hours from Now”. Options “8 Hours from Now” and “24 Hours from Now” do not meet the user's requirement because he/she wants to watch the movie 3 hours after ordering. “Now” option meets his/her requirement, but it is not economic since he/she would get exactly the same service as from option “2 Hours from Now”, but pays 2 dollars more (12 dollars vs. 10 dollars).

FIG. 5 is a flow chart of message and video stream exchanges between VOD system components when “Viewer Assisted” caching mechanism is employed. The message sequence when a viewer, John, selects a video program at 8 PM and decides to watch the it the next day at 9 PM is shown as follows:
(1) The viewer, John, picks the video program he wants to see and selects “24 Hours from Now” option with a remote controller;
(2) After getting the user input, ‘STB 1’ sends out a request message to ‘VOD Edge Server 1’, as marked as 101 in the diagram;
(3) ‘VOD Edge Server 1’ forwards the message to ‘Router 2’as marked as 102.

Here we assume ‘VOD Edge Server 1” doesn't have the video program on its local storage;
(4) ‘Router 2’ forwards the message to ‘Router 1’as marked as 103;
(5) ‘Router 1’ forwards the message to the ‘Cache Schedule Server’, as marked as 104;
(6) Upon receiving the message, ‘Cache Schedule Server’ doesn't request the “VOD Server” to start caching the video program immediately. Instead, it records the message and calculates what time is best to start caching based on the criteria discussed in [Para 14].

Also in FIG. 5, another viewer, Mary, books the same video program from ‘STB 3’ at 8:30 PM and decides to watch the video program the next day at 10 PM. The following is the message exchange sequence between VOD system components:
(1) The viewer, Mary, picks the video program and selects “24 Hours from Now” option with a remote controller;
(2) After getting the user input, ‘STB 3' sends out a request message to ‘VOD Edge Server 2’, as marked as 201 in the diagram;
(3) ‘VOD Edge Server 2’ forwards the message to ‘Router 3’, as marked as 202.

Here we assume ‘VOD Edge Server 2’ doesn't have the video program on its local storage;
(4) ‘Router 3’ forwards the message to ‘Router 4’, as marked as 203;
(5) ‘Router 4’ forwards the message to ‘Router 1’, as marked as 204;
(6) ‘Router 1’ forwards the message to the ‘Cache Schedule Server’, as marked as 205;
(7) Upon receiving the message, ‘Cache Schedule Server’ doesn't request the ‘VOD Server’ to start caching the video program immediately. Instead, it records the message and calculates what time is best to start caching based on the criteria discussed in [Para 14].

Up to this point, the ‘Cache Schedule Server’ has received two requests for the same video program, one from John and the other from Mary. If the ‘Cache Schedule Server’ calculates the best time to start caching the video program is 6 AM the next day, it could cache the video program to ‘VOD Edge Server 1’ and ‘VOD Edge Server 2’ by transferring the video program only once on the IP backbone. The following is the video stream transfer sequences between various VOD system components as depicted in FIG. 5:
(1) The ‘Cache Schedule Server’ sends out a command to the ‘VOD Server’ to start the caching process, as marked as 301;
   (2) Upon receiving the command, the ‘VOD Server’ sends out the video program in the form of a video stream to ‘Router 1’as marked as 302;
   (3) ‘Router 1’ forwards the video stream to ‘Router 2’, as marked as 303;
   (4) ‘Router 2’ forwards the video stream to ‘Router 3’ as market as 305. At the time, it drops a copy of the video stream to ‘VOD Edge Server 1’, as marked as 304;
   (5) Upon receiving the video stream, ‘VOD Edge Server 1’ stores the video program into its local storage, i.e., ‘Storage 1’, as marked as 306;
   (6) ‘Router 3’ forwards the video stream to ‘VOD Edge Server 2’, as marked as 307;
   (7) Upon receiving the video stream, ‘VOD Edge Server 2’ stores the video program into its local storage, i.e., ‘Storage 2’, as marked as 307.
      At this point, both ‘VOD Edge Server 1’ and ‘VOD Edge Server 2’ have a copy of the video program on their local storages.

At 8 PM the next day, viewer John turns on his TV and asks to watch the video program he requested the day before. The following is the message exchange sequence between VOD system components as depicted in FIG. 5:
(1) Viewer John ask to see the video program he requested the day before with a remote controller;
(2) ‘STB 1’ sends out a request message to ‘VOD Edge Server 1’, as marked as 401;
(3) ‘VOD Edge Server 1’ fetches the video program from its local storage, i.e., ‘Storage 1’, and sends it to ‘STB 1’ in the form of a video stream (since ‘VOD Edge Server 1’ has the video program cached in its local storage), as marked as 402;
(4) ‘STB 1’ forwards the video stream (possibly after some processing) to ‘TV 1’, as marked as 403;
(5) Viewer John starts watching the video program.

Similarly, at 10 PM the next day, viewer Mary turns on her TV and asks to watch the video program she requested the day before. The following is the message exchange sequence between VOD system components as depicted in FIG. 5:
(1) Viewer Mary ask to see the video program she requested the day before with a remote controller;
(2) Upon receiving the request, ‘STB 3’ sends out a request to ‘VOD Edge Server 2’, as market as 501 in the diagram;
(3) ‘VOD Edge Server 2’ fetches the video program from its local storage, i.e., ‘Storage 2’, and sends it to ‘STB 3’ in the form of a video stream (since ‘VOD Edge Server 2’ has the video program cached in its local storage), as marked as 502;
(4) ‘STB 3’ forwards the video stream (possibly after some processing) to ‘TV 3’, as marked as 503;
(5) Viewer Mary starts watching the video program.

The “Viewer Assisted” caching mechanism has the following benefits:
(1) ‘Cache Schedule Server’ doesn't always have to send a copy of a video program across the IP backbone in response to every request. Instead, it is possible for the ‘Cache Schedule Server’ to collect several requests (e.g., request from viewer John and request from viewer Mary) and satisfies them with only one transfer;
(2) The video program transfer process doesn't have to start immediately after the viewers request video programs. Instead, ‘Cache Schedule Server’ calculates when is the best time to start caching process based on criteria, such as user provided schedule, network traffic pattern, etc. In most of time, ‘Cache Schedule Server’ could pick an off-peek usage hour to do the caching and thus smoothes out the network traffic on the IP backbone;
(3) ‘VOD Edge Servers’ only need to store some top hit video programs and video programs that viewers actually requested for the next few days, so the local storage for ‘VOD Edge Servers’ can be substantially smaller than those when other caching mechanisms are employed;

When ‘User Assisted’ caching method is used, video programs requested by users could also be cached on local storages of users premises equipment (instead of being stored on storages of ‘VOD Edge Servers’) because the ‘VOD Edge Servers’ and the ‘VOD Server’ know exactly which users request for the video programs. The user premises equipment for caching the video programs could be STBs, or any storage equipment connected to STBs. When this method is used, even less storage is needed for each ‘VOD Edge Server’.

### BRIEF DESCRIPTION OF THE DRAWINGS

FIG. 1 is an example structure of an IPTV network that supports VOD service.

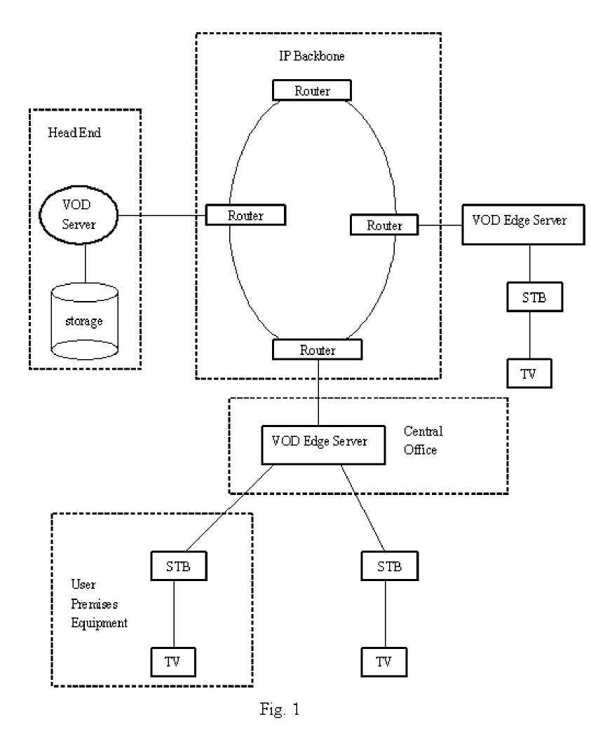

FIG. 2 is a flow chart of message and video stream exchanges between an STB and a VOD Server where no cache mechanism is employed.

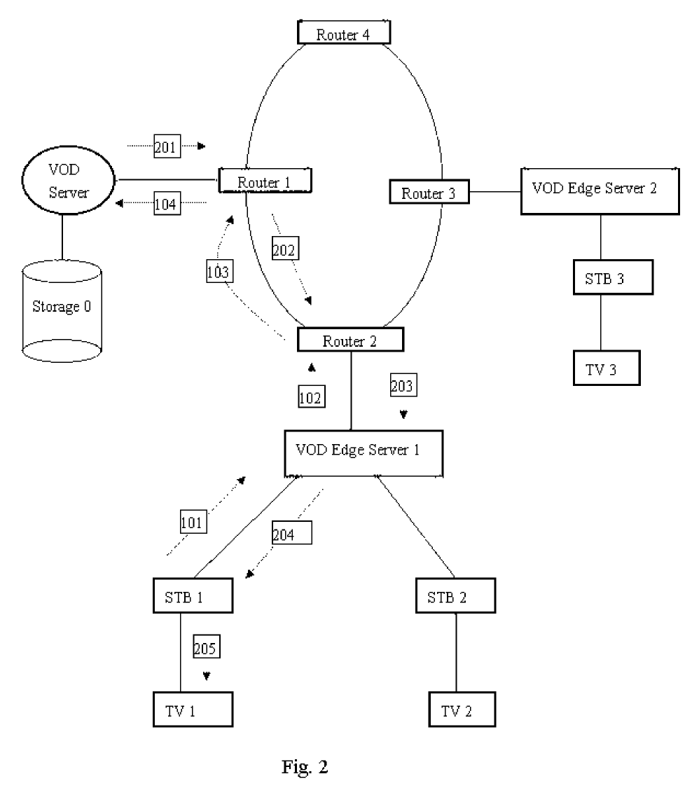

FIG. 3 is a flow chart of message and video stream exchanges between an STB and a VOD Server where “Push Update” caching mechanism is employed.

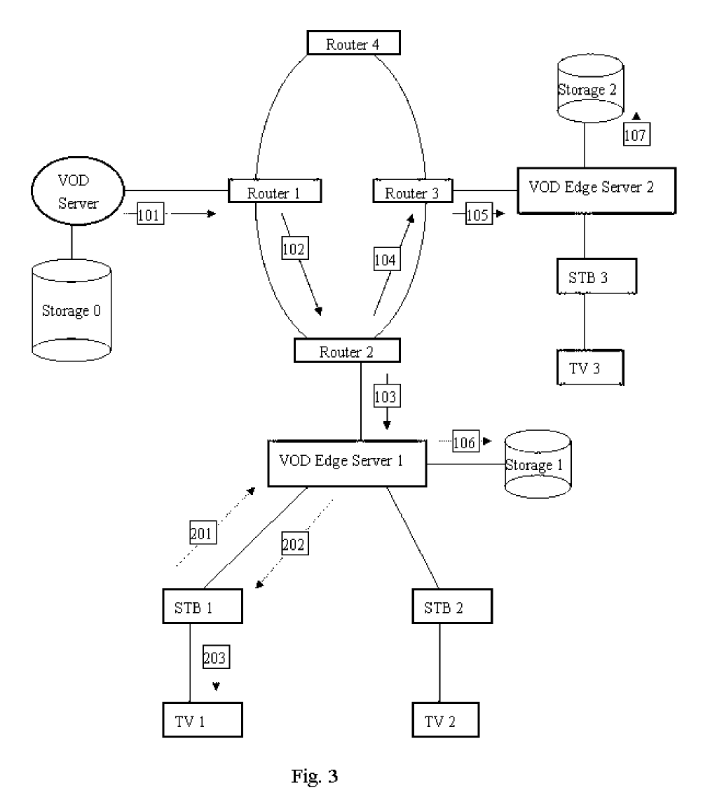

FIG. 4 is a flow chart of message and video stream exchanges between an STB and a VOD Server where “Dynamic Stream Caching” mechanism is employed.

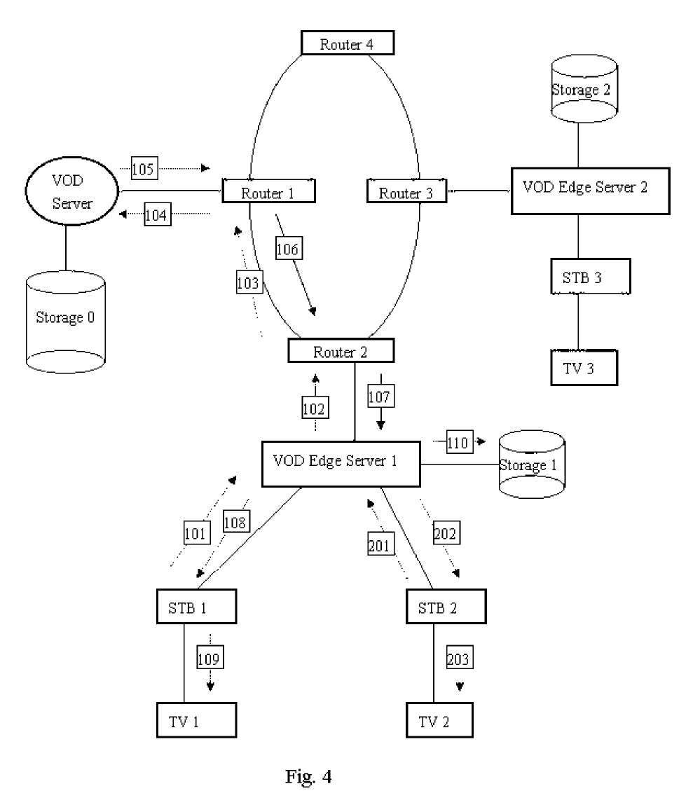

FIG. 5 is a flow chart of message and video stream exchanges between an STB and a VOD Server where “User Assisted Caching” mechanism is employed.

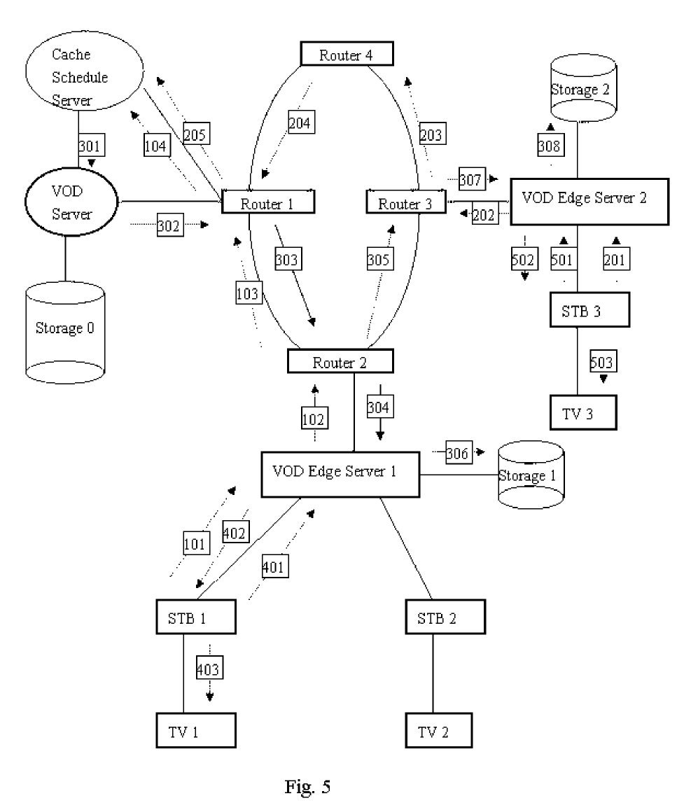

FIG. 6 is an example user interface shown on TV when “User Assisted Caching” mechanism is used in a VOD system.

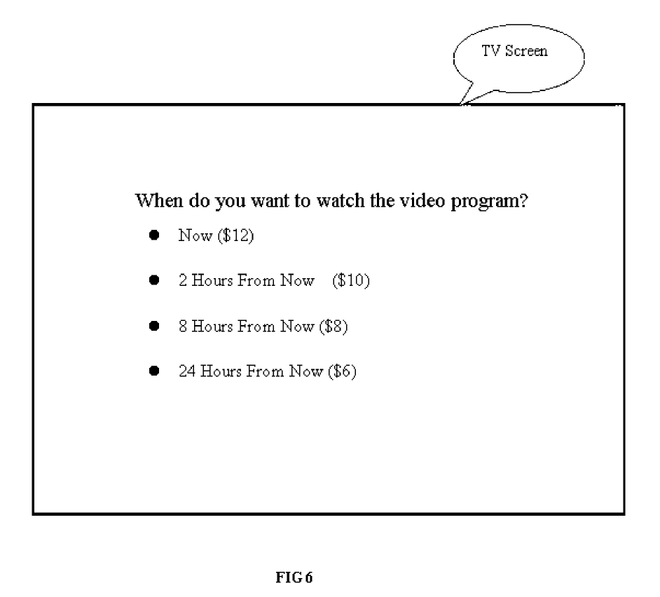

FIG. 7 is another example user interface shown on TV when “User Assisted Caching” mechanism is used in a VOD system.

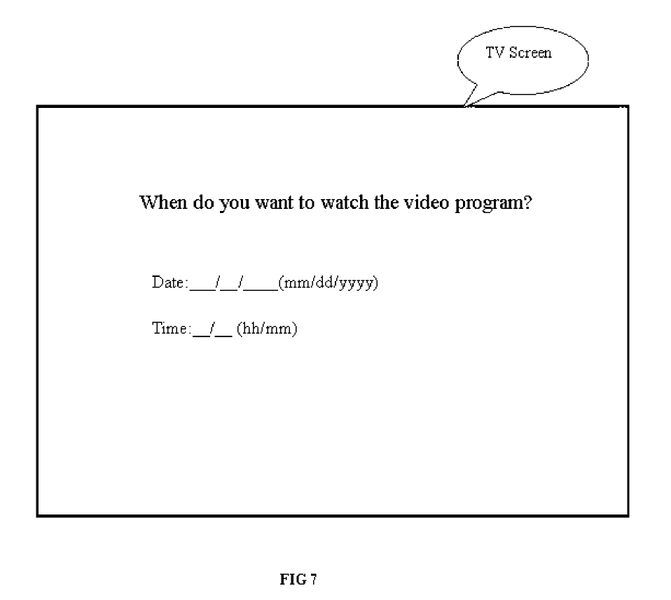

What is claimed is:

1. A method for VOD system to efficiently cache video contents on its edge servers' local storage comprising:
A user interface to allow VOD service users to specify not only the name of the video programs, but also the time they want to start watching the video programs they request;
A VOD system component, ‘Cache Schedule Server’, to receive and store video requests from users and calculates when is the best time to start transfer the requested video programs from VOD server to VOD edge servers for caching based on criteria such as inputs (name of the video program, time, date, etc.) from user interface, network traffic pattern during a day, among others. The ‘Cache Schedule Server’ could be implemented as a standalone server in a VOD system, or a software module incorporated in the VOD server.

2. The method of claim 1, wherein video contents are cached on local storages of user premises equipment.

3. The method of claim 1, wherein the user interface comprises:
A question for the time the VOD service users want to start watching the video programs requested and a list of options to the question. VOD service users are able to select the options with remote controllers.

4. The method of claim 1, where in the user interface comprises:
A question for the time the VOD service users want to start watching the video programs requested and input fields for date and time corresponding to the question. VOD service users are able to input the date and time with remote controllers.

5. The method of claim 1, wherein the functionalities of the ‘Cache Schedule Server’ comprise:
Receiving video requests from VOD service users. Each request contains at least two pieces of information, i.e., name of the requested video program (or video ID uniquely assigned by the VOD system operator), time and date the requesting user wants to start watching the video program;
Deciding when to start transferring out the video for caching (and possibly viewing) based on the information encapsulated in the requests and network traffic pattern during a day;
Commanding the VOD server to start transferring out video programs in the form of video streams to VOD edge server(s) for caching. The video streams travels from the VOD server to edge server(s) via the IP backbone.
